(19) United States
(12) Patent Application Publication
(10) Pub. No.: US 2008/0133681 A1
(43) Pub. Date: Jun. 5, 2008

(54) SYSTEM AND METHOD FOR DIAGNOSIS OF AND RECOMMENDATIONS FOR REMOTE PROCESSOR SYSTEM

(76) Inventors: Troy V. Jackson, Brookline, MA (US); Omer D. Lizotte, Brockton, MA (US); Keith W. Michel, Watertown, MA (US); Singu K. Srinivas, Needham, MA (US); Michael L. Wexler, Cambridge, MA (US)

Correspondence Address: COOLEY GODWARD KRONISH LLP;ATTN: Patent Group, Suite 1100, 777 - 6th Street, NW, WASHINGTON, DC, 20001, US

(21) Appl. No.: 11/870,984

(22) Filed: Oct. 11, 2007

Related U.S. Application Data
(60) Provisional application No. 60/829,393, filed on Oct. 13, 2006.

(51) Int. Cl. G06F 15/16; G06F 9/44

(52) U.S. Cl. 709/206; 709/204; 717/106

(57) ABSTRACT

In one embodiment, a customer processor system is characterized via a remote client installed on the customer processor system. The remote client can collect, process and send characterization data about the customer processor system to a application server. The characterization data can then be used to make recommendations to or predictions about the customer. In some embodiments, other types of data can be used such as customer usage data and customer preference data for multiple customers.

### CROSS-REFERENCE TO RELATED APPLICATIONS

This application claims priority to U.S. Provisional Application No. 60/829,393 entitled “System And Method For Diagnosis Of And Recommendations For Remote Processor System” filed Oct. 13, 2006; the entire disclosure of which is incorporated herein by reference.

### BACKGROUND

The invention relates generally to the diagnosis of a remote processor system. In some embodiments, classifications, recommendations and predictions are made based on the characterization data of the remote processor system.

Currently, owners of personal computers use audio phone calls and online instant-messaging with technical staff to seek assistance to problems with their hardware and/or software. Both of these mechanisms have similar shortcomings: the technician assisting the customer does not have sufficient access to or data from the customer's personal computer. Rather, the technician has to rely on the customer's communication ability to describe the situation and then the technician can try to implement a solution via the audio phone call or online instant messaging.

Thus, a need exists for improved systems and method for diagnosing and making recommendations for remote processor systems such as a customer's personal computer.

### SUMMARY

In one embodiment, a customer processor system is characterized via a remote client installed on the customer processor system. The remote client can collect, process and send characterization data about the customer processor system to a application server. The characterization data can then be used to make recommendations to or predictions about the customer. In some embodiments, other types of data can be used such as customer usage data and customer preference data for multiple customers.

### BRIEF DESCRIPTION OF THE FIGURES

FIG. 1 shows a system block diagram of the overall system, according to an embodiment of the invention.

FIG. 2 shows a software diagram for the overall system, according to an embodiment of the invention.

FIG. 3 shows a method for diagnosing and aiding a customer processor system, according to an embodiment of the invention.

FIG. 4 shows a browser window having a summary of characterization information and associated recommendations, according to an embodiment of the invention.

FIG. 5 shows a method for segmenting customer processor system information via a segmentation engine, according to an embodiment of the invention.

FIG. 6 shows a multidimensional segmentation chart for a segmentation engine, according to an embodiment of the invention.

FIG. 7 shows a multidimensional interest table for a segmentation engine, according to an embodiment of the invention.

FIG. 8 shows a method for generating recommendations via a recommendation engine, according to an embodiment of the invention.

FIG. 9 shows a method of predicting customer behavior via a predictive engine, according to an embodiment of the invention.

FIG. 10 shows an example of a graphical user interface (GUI) showing enrollment by the customer and installation of the remote client at a customer processor system, according to an embodiment of the invention.

FIG. 11 shows an example of a GUI displaying characterization data in the form of colored indicators and displaying recommendations, according to an embodiment of the invention.

FIG. 12 shows another example of a GUI displaying more detailed characterization data in addition to colored indicators and displaying recommendations, according to an embodiment of the invention.

FIG. 13 shows an example of a GUI displaying interest paths and inviting the customer to seek recommendations, according to an embodiment of the invention.

FIG. 14 shows another example of a GUI displaying characterization data, according to an embodiment of the invention.

FIG. 15 shows yet another example of a GUI displaying characterization data, according to an embodiment of the invention.

FIG. 16 shows yet another example of a GUI displaying characterization data including colored indicators and displaying multiple other status windows, according to an embodiment of the invention.

### DETAILED DESCRIPTION

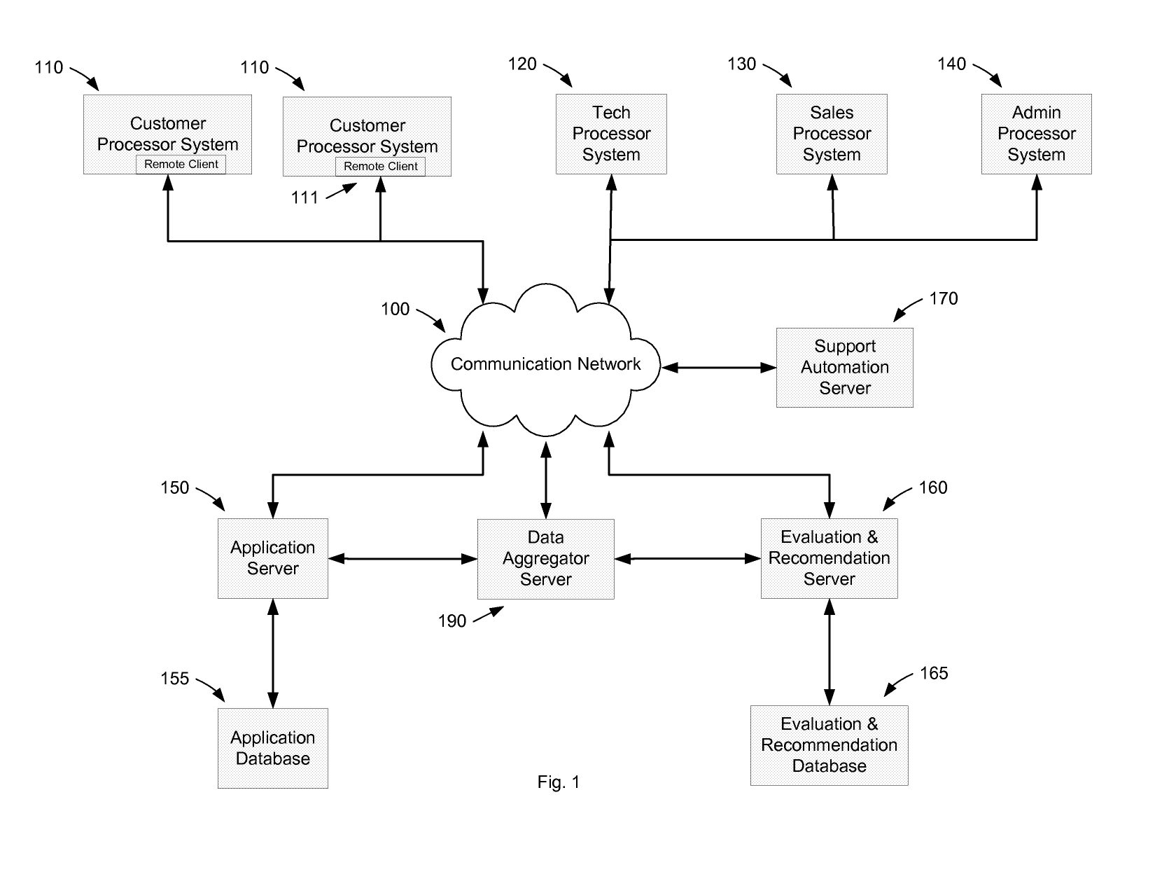

FIG. 1 shows a system block diagram of the overall system, according to an embodiment of the invention. As shown in FIG. 1, the overall system includes a communication network 100, a customer processor system 110, a remote client 111, a technician processor system 120, a sales processor system 130, an administrative processor system 140, an application server 150, an application database 155, an evaluation-and-recommendation server 160, an evaluation-and-recommendation database 165, a support automation server 170 and a data aggregator server 190.

The communication network 100 is coupled to each customer processor system 110, technician processor system 120, sales processor system 130, and administrative processor system 140. Communication network 100 is also coupled to the application server 150, evaluation-and-recommendation server 160, support automation server 170 and data aggregator server 190. The application server 150 is coupled to the application database 155, to data aggregator server 190 and to the evaluation-and-recommendation server 160, which also is coupled to the evaluation-and-recommendation database 165. Additionally, the recommendation server 160 can communicate with the technician processor system 120, the sales processor system 130, and the administrative processor system 140 via communication network 100. Recommendation server 160 is also coupled to data aggregator server 190.

Each customer processor system includes a remote client 111 that can communicate over the communication network 100 with the application server 150, the evaluation server 160, and the support automation server 170. The technical processor system 120, sales processor system 130, and administrative processor system 140 can communication with the remote client 111 through the communication network 100.

Communication networks 100 can include, for example, intranets, the internet, and the like. The remote client 111 is an autonomous software component or client located in the memory of the customer processor system 110. The remote client 111 executes in coordination with the application server 150, the evaluation-recommendation server 160 and support automation server 170 (discussed below), to deliver automatically software products and services to the customer processor system 110. Customer processor systems 110 can include, for example, IP enabled appliances/devices, personal computers, servers, workstations, thin-clients, personal digital assistants (PDAs), mobile communication devices such as cell phones, etc. As discussed in further detail below, the remote client 111 is configured to collect and process data (also referred to herein as “characterization information”) from the customer processor system 110 and send it to application server 150, evaluation-and-recommendation server 160, support automation server 170 and/or data aggregator server 190. In one embodiment, the delivery of the software products and services to the customer processor system 110 can be performed manually through actions by the customer associated with customer processor system 110 or a technician associated with technician processor system 120. Alternatively, some of the software products and services can be delivered automatically (for example upon enrollment in the one or more of services described herein) while others are manually deployed. Such software products and services can include, for example, the remote client 111, third-party software products, patches and upgrades of the same and/or customized instructions such as command scripts.

The evaluation-and-recommendation server 160 profiles the customer associated with a given customer processor system 110 and generates recommendations based off the information stored in the evaluation-and-recommendation database 165. Evaluation-and-recommendation database 165 contains, but is not limited to user profile data, billing information, technician preference, marketing data, inventory data, and segmentation data. This information and data along with predefined rule sets enable the evaluation-and-recommendation server 160 to generate specific recommendations for and predictions about the customer. Relevant information can then be sent to the technician processor system 120, sales processor system 130, administrative processor system 149, and/or customer processor system 110.

The technician processor system 120 can receive recommendations from the evaluation-and-recommendation server 160. The recommendations can be specific for the customer associated with a given customer processor system 110 and can be tailored to provide the customer with suggestions and options for modifying the existing processor software or adding processor software, as discussed in further detail below. The technician processor system 120 can modify or omit the recommendations to be presented to a customer when assisting the customer, for example, through a telephone conversation or over an on-line chat session. The sales processor system 130 receives sales specific recommendations on products and services the customer needs or may want. The administrative processor system 140 receives information from servers, technicians, and/or sales entities about the status and results of actions taken; the administrative processor system 140 can use this information to perform administrative functions associated with, for example, servers 150, 160 and/or 170, and/or processor systems 120, 130 and/or 140.

The application server 150 maintains the relationship between applications and the customer. The application server 150 can manage, for example, information packaging and updates, software downloads, customized instructions such as command scripts and/or marketing downloads maintained, for example, in the application database 155. The software downloads can be obtained from, for example, the application database 155, a third-party server or database, or any combination thereof. For example, antivirus software can be retrieved from a third party such as McAfee by the application server 150. Alternatively, the remote client 111 can act as a proxy on a customer's behalf to third parties, downloading the third-party software directly to the customer processor system 110. In one embodiment, the remote client 111, evaluation-and-recommendation server 160, and/or technician processor system 120 can each retrieve third-party software so that downloads are performed in a coordinated manner among these systems. In the case where the remote client 111 acts autonomously to download software, the support automation server 170 coordinate such activities with the remote client 111.

The data aggregator server 190 receives data from multiple sources including the application server 150 and aggregates this data into an aggregated form. Such aggregated data can be, for example, forwarded to evaluation-and-recommendation sever 160 for subsequent processing. Application server 150 and/or evaluation-and-recommendation sever 160 can forward information back to data aggregator server 190 so that future data is aggregated in a different form as appropriate.

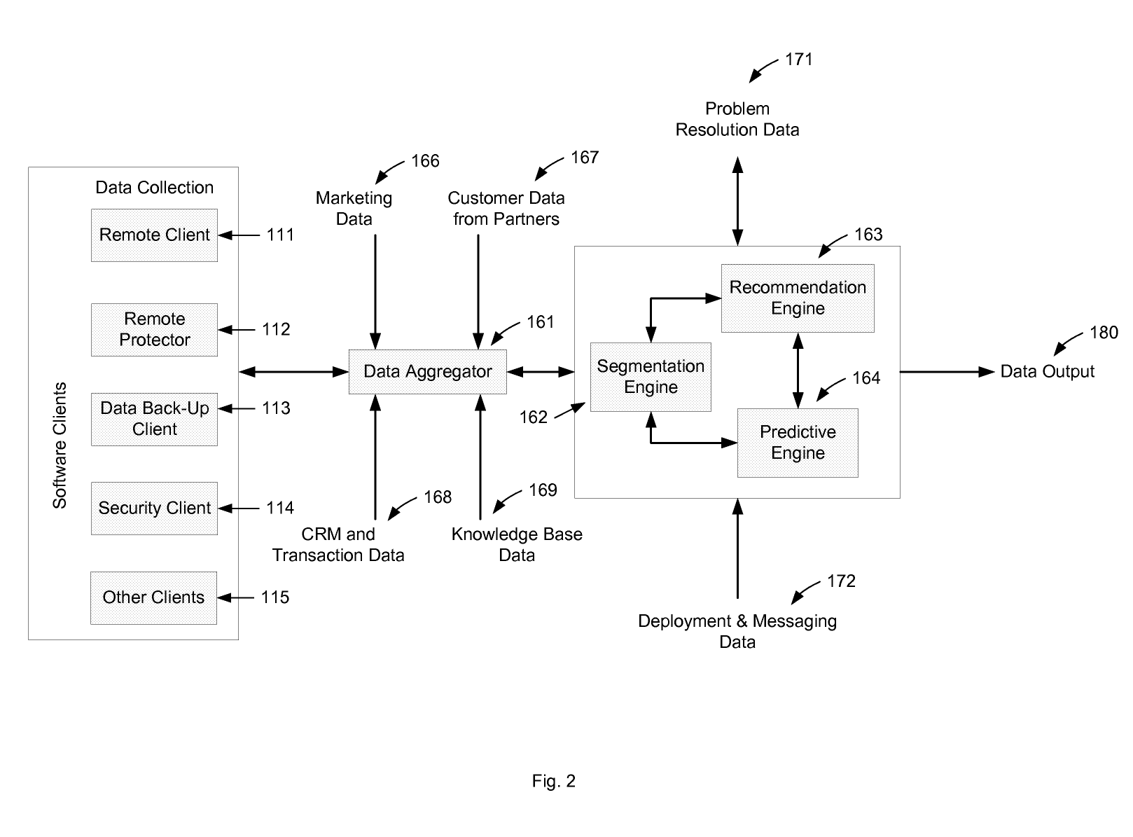

FIG. 2 shows a software diagram for the overall system, according to an embodiment of the invention. As shown in FIG. 2, data collection software clients include, for example, a remote client 111, a remote protector 112, a data back-up client 113, a security client 114, and other possible clients 115. The overall system also includes a data aggregator 161, a segmentation engine 162, a recommendation engine 163, a predictive engine 164, marketing data 166, customer data from partners 167, CRM and transaction data 168, knowledge base data 169, problem resolution data 171, deployment and messaging data 172, and data output 180.

Data collected from the software clients 111-115, as well as marketing data 166, customer data from partners 167, CRM and transaction data 168, and knowledge base data 169 are amassed together via the data aggregator 161, which then sends the aggregated data to the segmentation engine 162. The segmentation engine 162, recommendation engine 163, and the predictive engine 164 can communicate bi-directionally among each another. Problem resolution data 171 and deployment and messaging data 172 are sent to the segmentation engine 162, recommendation engine 163 and/or predictive engine 164 as needed. The recommendation engine 163 and predictive engine 164 can send data output 180 to an appropriate recipient such as customer processor system 110, technician processor system 120, sales processor system 130, administration processor system 140. Segmentation engine 162, recommendation engine 163 and/or predictive engine 164 can also send updated problem resolution data 171 back to a system (not shown) configured to received such problem resolution data 171.

Software clients 112-115 can be, for example, third-party clients that can be used in the updating and upgrading of a customer processor system 110. These clients can have the most up-to-date patches and software for use by the remote client 111, evaluation-and-recommendation server 160, the technician processor system 120, and the support automation server 170. Alternatively, software clients 112-115 could be part of the remote client 111, the evaluation-and-recommendation server 160, or any combination therein. The remote client 111, evaluation-and-recommendation server 160, and/or the technician processor system 120 can decide when to use third-party software to facilitate the correction of a problem associated with customer processor system 110.

The characterization data of the remote client 111 can quantitatively and qualitatively describe the customer processor system 110. The characterization data of remote client 111 can be used, for example, to determine whether any software patches, upgrades and/or updates are recommended for customer processor system 110. The characterization data of the customer processor system 110 can be compared, for example, to data from a third-party entity maintaining a predetermined database of software patches, upgrades and/or updates. Alternatively, the collective characterization data from multiple customer processor systems 110 can be use to determine whether any software patches, upgrades and/or updates are recommended for customer processor system 110. In such an embodiment, recommendations can be based on, for example, a customer having the most current patches, upgrades and/or updates; this indicates the availability such current software patches, upgrades and/or updates Such approaches can also be used for hardware devices and/or components as well.

The segmentation engine 162 is multidimensional, the profiling process is based on segmentation schemes and algorithms that take customer information, and categorize a customer into one or many predefined segments through predefined rule sets. The resulting segment is indicative of the customer's interest, stability level, and/or level of technical proficiency. The engine has the flexibility to have dimensions added or removed and have granularities increased or decreased. Due to changes in the user base, the engine can re-segment customers.

The recommendation engine 163 assigns tracking indicators based, at least in part, on the segment associated with that customer. Based on the tracking indicator, the engine generates a prioritized list of software, hardware, and service recommendations for the user. Historically successful solutions implemented on a specific community's problems help dictate a recommendation's priority. Such historically successful solutions could be, for example, the purchase of a specific software, the downloading of a specific patch, and/or the execution of maintenance-related command instructions/scripts, either by the customer or on behalf of the customer. In some embodiments, the community member who has the most advanced setup as well as the fewest problems could become an archetype upon which recommendations for other community members can be prioritized. The engine tracks and rotates the recommendations to prevent the customer from receiving duplicate recommendations and/or recommendation types the customer has not accepted previously. The tracking indicator can be used so that different constituents receive specialized customer-problem and customer-expertise specific recommendations.

The predictive engine 164 anticipates customer behavior for usage by, for example, sales entities, customer service technicians and/or third-parties associated with the overall service. In some embodiments, the recommendation engine 163 and prediction engine 164 cooperate to collectively perform some of all of these functions. The customer is assigned a score by the engine based on algorithms. The data along with predefined rules dictate the scope, which is the basis of the prediction. One prediction can be, for example, a customer's percent chance to upgrade a specific piece of software. The prediction algorithms can be validated and revised based on the customer's actions. The algorithms can update through an automated iterative feedback loop of customer actions.

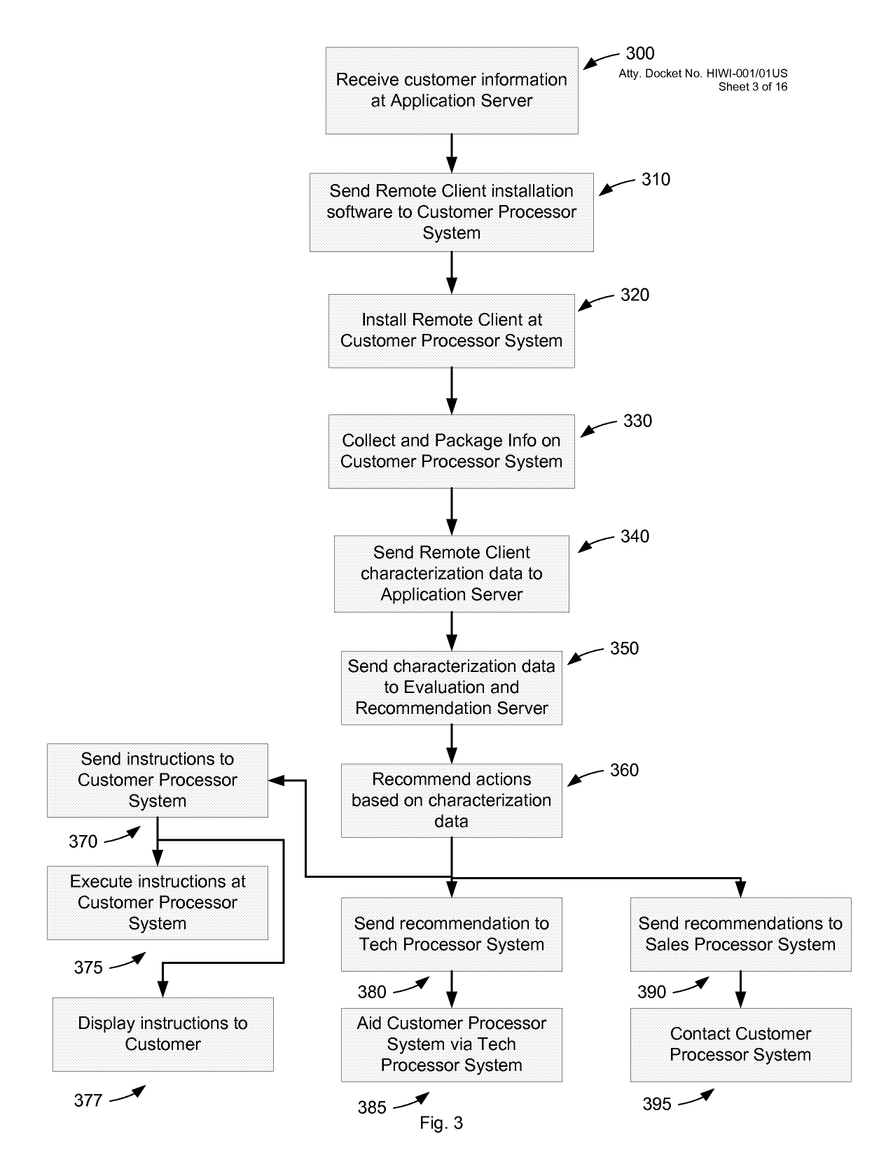

FIG. 3 shows a method of diagnosing and aiding a customer processor system 110, according to an embodiment of the invention. At 300, the overall system receives the information from customer processor system 110 at the application server 150. Such information from customer processor system 110 can be, for example, an enrollment request to sign up for the one or more of the services described herein when the customer is a new customer. Alternatively, such information from customer processor system 110 can be, for example, characterization information when the customer is a previously enrolled customer.

At 310, the overall system sends remote-client installation software to the customer processor system 110. At 320, the remote client 111 is installed at the customer processor system 110 based on the remote-client installation software. The remote client can be automatically installed once received at the customer processor system 110. Alternatively, after the remote-client installation software has been received at the customer processor system 110, the remote client 111 can be installed in response to, for example, a prompt by the customer via customer processor system 110, a prompt by a technician at technician processor system 120, or a prompt by a salesperson at sales processor system 130.

At 330, the remote client 111 executes one or more software processes, such as script commands, to collect and package data (i.e., characterization data) describing for example software components, hardware components and/or configuration information of the same for the customer processor system 110. Alternatively, the substance of the script commands can be executed manually, for example, via a technician. Additionally, the remote client 111 can maintain a log of actions initiated by script commands and their results. Upon request, this log can be sent to the technician associated with technician processor system 120. Alternatively, the log can be sent automatically to the technician associated with technician processor system 120, for example, at periodic intervals, which can be selected and scheduled. Such periodic intervals can be maintained over a period of time, or can be scheduled to varied as desired. Characterization data describing the customer processor system 110 can include, for example, identifying information of the hardware components of the customer processor system 110 such as the model and serial number of the processor, the model and capacity of the memory, the amount of memory available, and the identities of associated peripherals such as digital cameras, printer, etc. Characterization data of a customer processor system 110 can also include, for example, identifying information of the software installed on customer processor system 110 such as the operating system, peripheral drivers, and third-party software.

Characterization data of a customer processor system 110 can also include information relating to usage such as, for example, whether a particular software component has been used (not merely identifying whether the software has been installed). Such information can be obtained, for example, through the use of command scripts configured to examine specific portions of memory indicative of usage for a given software module or product.

At 340, the remote client 111 sends the diagnostic data to the application server 150. The collection and sending of diagnostic data can be performed periodically, on given time schedule or in response to a particular customer or technician action. For example, the remote client 111 can collect and send characterization data once every day or once every week. Alternatively, the remote client 111 can collect and send characterization data when the customer installs a new software component. In yet another alternative, the remote client 111 can collect and send characterization data upon request by a technician during a service session with the customer associated with customer processor system 110. In some embodiments, the remote client 111 can automatically collect and send characterization data at at periodic intervals, which can be selected and scheduled. Such periodic intervals can be maintained over a period of time, or can be scheduled to varied as desired.

At 350, the application server 150 sends the diagnostic data to the evaluation-and-recommendation server 160. The evaluation-and-recommendation server 160 can recommend actions 360 based on the characterization data and the data stored in the evaluation-and-recommendation database 165. At 370, evaluation-and-recommendation server 160 sends instructions to the customer processor system 110; at 375, instructions are executed at the customer processor system 110; at 377, instructions are displayed to the customer at the customer processor system 110.

Such instructions can result in updates to the remote client 111 and/or updates to the customer processor system 110. In addition or alternatively, such instructions can result in recommendations being provided to the customer associated with the customer processor system 110. The recommendations can be personalized to the customer and the customer processor system 110. The recommendations can also be personalized based, at least in part, on registration information provided by the customer or data appended from other external sources. In some embodiments, the recommendations can be specific to an issue defined by the customer and/or customer processor system. Such recommendations can be provided to the customer, for example, through pop-up windows, dedicated windows, message balloons or a browser window specifically activated to display the recommendations. Such windows or balloons can, for example, summarize characterization information as well as recommend software updates or modification, hardware updates, etc.

In other words, the evaluation-and-recommendation server 160 can output/push the recommendations to the customer processor system 110. In some embodiments, a profile customer survey associated with the specific customer processor system 110 can be used to define segmentation and hierarchy of messages/recommendations to be delivered to that customer. The profile customer survey can include, for example, personal information of the user, an indication of the user's technical proficiency and comfort level, system-specific information about the customer processor system, etc. Specifically, an algorithm that helps produce the recommendation can be updated dynamically through, for example, an automated iterative feedback loop of customer actions discussed above. Said differently, the algorithm can be updated based on, for example, a specific response of the customer to the recommendation. For example, the algorithm can be updated to account for the fact that the specific customer does not use media players and that future recommendations should not include media player recommendations.

Once the instructions have been executed, the remote client 111 can verify that the instructions have been successful. This can be, for example, confirming that a problem has been fixed or confirming that new software has been effectively installed. If the instructions have not been successful, the remote client 111 can send the new characterization data to the application server 150 for further processing.

At 380, evaluation-and-recommendation server 160 sends instructions to the technician processor system 120; at 385, instructions are executed at the technician processor system 120. When the instructions include recommendations, a technician associated with the technician processor system 120 can analyze the recommendations in addition to the diagnostic data. The technician can alter or omit the recommendation when communicating with the customer at customer processor system 110. The technician processor system 120 can send the recommendation (or a modified recommendation) to the customer processor system 110. The remote client 111, autonomously, in conjunction with the customer associated with the customer processor system 110, or on command from the technician associated with technician processor system 120, can implement the recommendation from the technician.

In some embodiments, the technician can activate a software toolbox that is embedded within the remote client 111 and the evaluation-and-recommendation server 160. The software toolbox can include one or more third-party software applications, components, custom scripts and/or macros, and can be represented by specific icons to specific features within one or more of the third-party software applications or components. A given software toolbox can be specific to a given technician enabling that technician to add software to or delete software from their respective software toolboxes. Technicians can also define multiple instructions within their respective software toolbox to, for example, install, execute and uninstall multiple software applications or components upon activation of an icon of the toolbox, etc.

In some embodiments, the evaluation-and-recommendation server 160 can include a management pack that enables seamless instrumentation and management of the third-party software for a customer. Specifically, the management pack can execute security algorithms, updates, recommendations for the customer processor system 110 independent of displaying results to the customer and/or receiving input from the customer. The management pack can also control third-party software applications or components. For example, a technician can use the management pack to install, execute and uninstall a security software application without displaying items to the customer and/or receiving input from the customer. The customer may or may not receive an indication or output associated with the security software application during installment, execution and/or un-installment.

Once the instructions have been executed, the remote client 111 can verify that the instructions have been successful. This can be, for example, confirming that a problem has been fixed or confirming that new software has been effectively installed. If the instructions have not been successful, the remote client 111 can send the new characterization data to the application server 150 for further processing.

At 390, evaluation-and-recommendation server 160 sends recommendations to the sales processor system 130; at 395, the customer can be contacted by a sales representative associated with sales processor system 130 based on the recommendations. The recommendations can include recommended methods for contacting the customer such as by telephone, direct mail, electronic mail, etc. The recommendations can also include what products the customer may be interested in or may need. In some embodiments, the recommendations, determined by the evaluation-and-recommendation server 160, can include or indicate a marketing message for a product or service (e.g., an advertisement) that has been identified as being of potential interest to the customer as well as a preferred communication channel through which the customer would be most likely to read the message and/or purchase the product or service. For example, the marketing message could include a link to purchase ink from a specific vendor when the customer is out of ink. The message could be sent via email when the customer has been identified as technically advanced and the predictive engine 164 has predicted that the customer would prefer to be contacted via email. A success rate for a given customer profile (e.g., the number of confirmed purchases versus the number of potential purchases of the product by one or more customers contacted via the predicted preferred communication channel and having similar characterization data) can be tracked and used to modify the algorithm of the predictive engine 164. This allows the algorithm of the predictive engine 164 to become more accurate in predicting appropriate marketing messages and preferred communication channels.

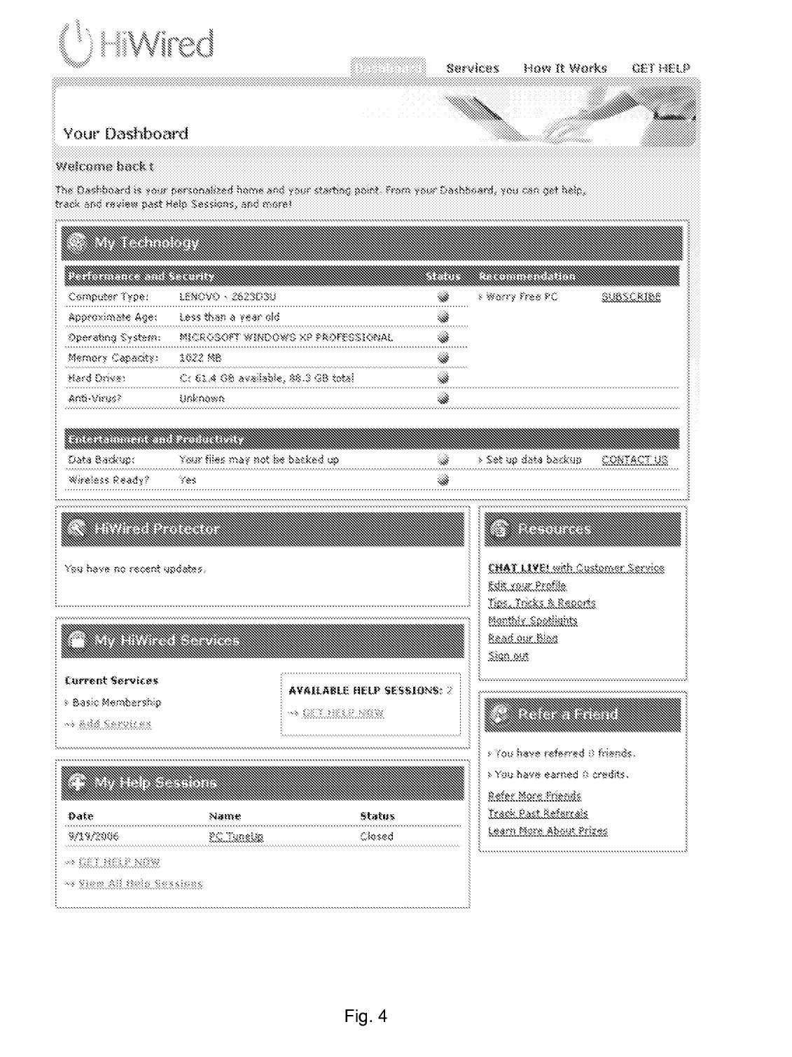

FIG. 4 shows an example of such a browser window specifically activated to display the recommendations. As shown in FIG. 4, the window displays a list summarizing the current diagnostic information for customer processor system 110. The list groups characterization information by topic to facilitate the reader's comprehension of the summary. One group, for example, is performance and security, which can contain the list member and memory capacity. The status of each list member is shown via a colored indicator. The coloring scheme of the indicator, for example, can mimic that of a traffic light, with green meaning no warnings or issues, yellow meaning warning of potential issues, and red meaning issues need to be addressed. The window also can contain a list of recommendations with each recommendation grouped in the same manner as the summary list members.

Returning to FIG. 3, at 380, evaluation-and-recommendation server 160 sends recommendations to the technician processor system 120. At step 385, the technician associated with the technician processor system 120 can then aid the customer associated with the customer processing system 110 in solving a problem or taking proactive action to avoid a future problem.

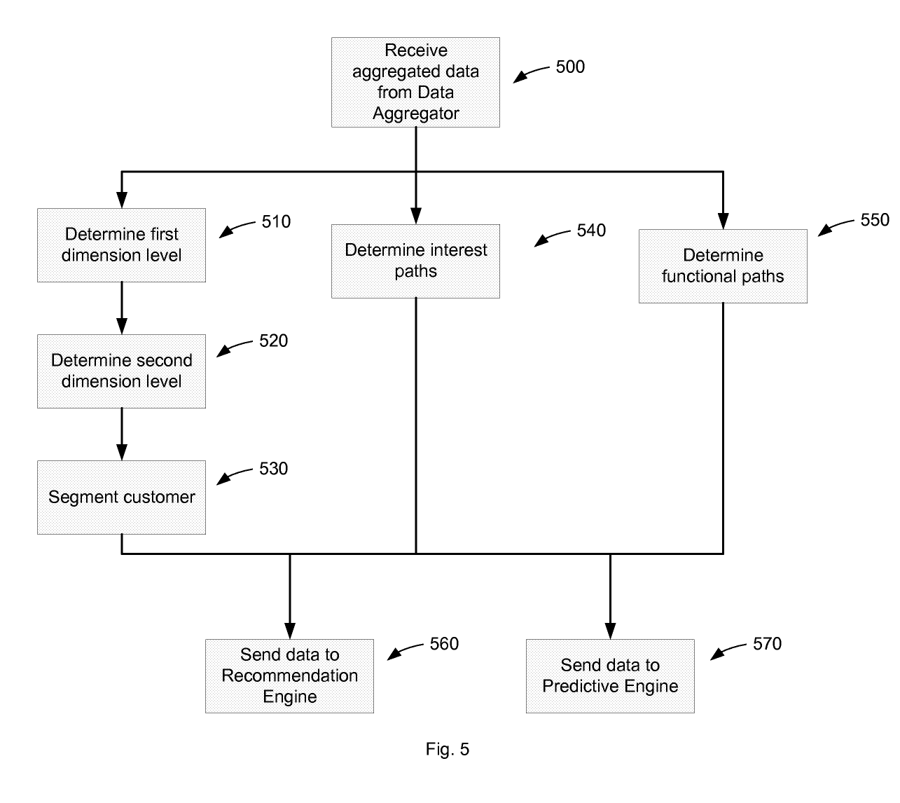

FIG. 5 shows a method for segmenting customer processor system information via a segmentation engine, according to an embodiment of the invention. At 500, the segmentation engine 162 receives aggregated data from the data aggregator 161. The aggregated data can be based on, for example, data from data collection entities 111 through 115, marketing data 166, customer data from partner 167, CRM and transaction data 168 and knowledge base data 169. In other words, the aggregated data is produced by data aggregator 161 based on numerous sources of data such that the data is collated and packaged into a form compatible for the segmentation engine 162.

At 510 and 520, the segmentation engine 162 determines a first dimensional value and a second dimensional value, respectively, based on the aggregated data. In one embodiment, the first dimensional value is the technical stability of the customer processor system 110 and can be based on, for example, the technical stability of the hardware components of the customer processor system 110, the technical stability of the software components of the customer processor system 110 and/or the collective technical stability of the hardware components and the software components of the customer processor system 110. In this embodiment, the second dimensional value is the comfort level of the customer associated with the customer processor system 110 and can range between a neophyte level of comfort to an expert level of comfort. Based on such dimensions, a multidimensional space can be defined to set forth, for example, bins or segments by which a given customer can be characterized.

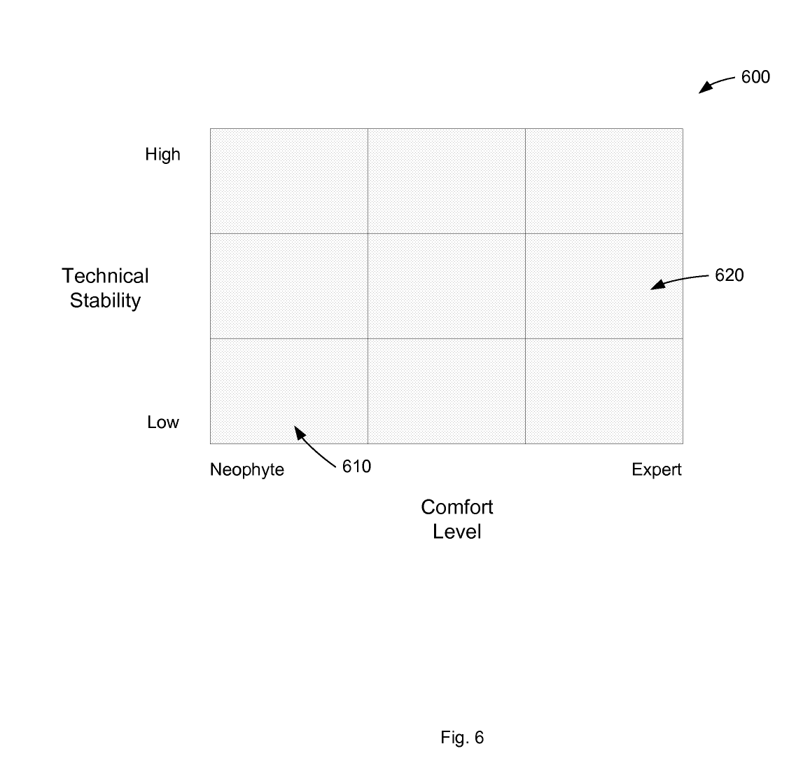

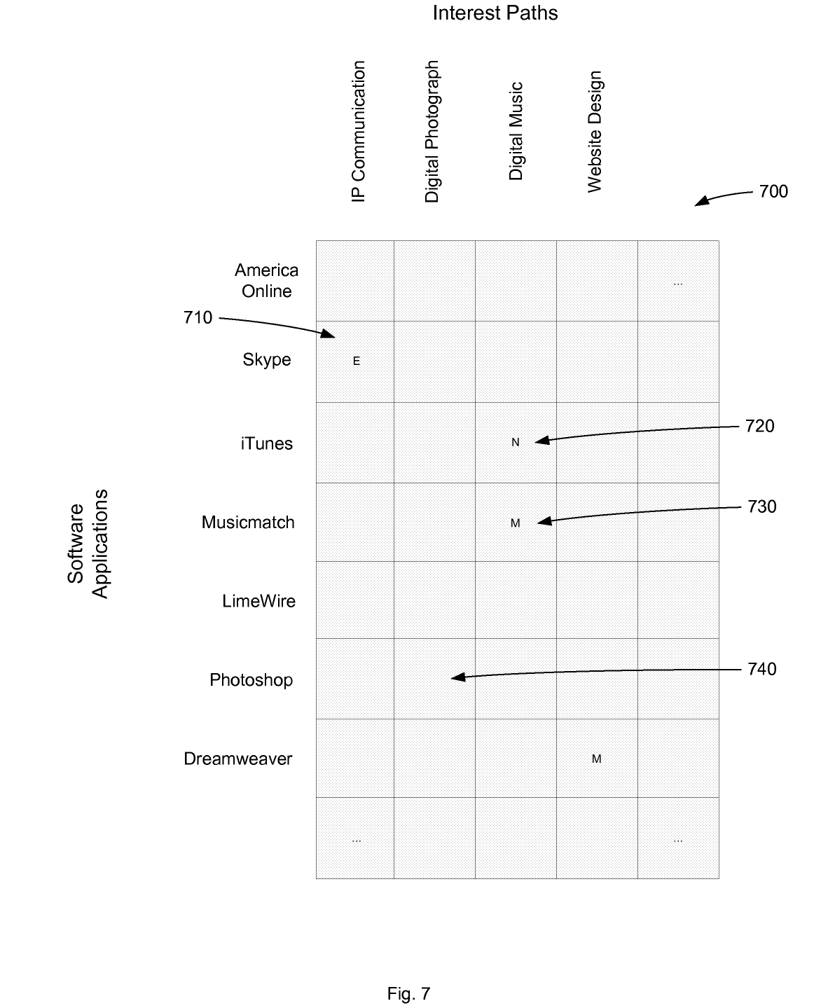

FIG. 6 shows an example a multidimensional segmentation chart for the segmentation engine, according to an embodiment of the invention. As shown in FIG. 6, the segmentation chart defines nine possible segments based on two dimensions: technical stability and comfort level. Technical stability ranges from low technical stability to high technical stability. The technical stability of a customer processor system 110 can be determined, for example, based on its physical characteristics such as the processor system's age, available memory, processor speed, and/or memory-loss ratios. Comfort level ranges from neophyte to expert can be determined based on data stored in the evaluation-and-recommendation database as discussed in more detail below in connection with FIG. 7. Although the multidimensional segmentation chart shown in FIG. 6 has two dimensions with a total of 9 segments, any number of dimensions and segments are possible. For example, in an alternative embodiment, a third dimension relating to customer service level can be added to the other two examples of the dimensions. Such a third dimension can provide segmentation based on whether the customer has enrolled in a basic or advanced level of service. Similarly, rather than dividing each dimension into three portions, each dimension can be divided into any number of portions such as 5 or 10 portions. Also, the number of portions for each dimension can vary and need not be identical.

Returning to FIG. 5, at 530, segmentation engine 162 segments the customer associated with the aggregated data into one of the segments. Following the example of FIG. 6, a given customer having a neophyte level of comfort and a low technical stability associated with its customer processor system can be identified as being associated with segment 610. For another example, another given customer having an expert level of comfort and a medium technical stability associated with its customer processor system can be identified as being associated with segment 620.

In addition to segmenting a customer based on the aggregated data, the segmentation engine 162 can identify paths associated with a given customer. At 540, the segmentation engine 162 identifies interest paths associated with the customer based on the aggregated data. An interest path can be metric in which a customer's interest in a given topic or categories of processor usage can be identified and/or measured based on the aggregated data. An interest path can include, for example, digital photography or digital music. Each interest path can be associated with a tag having a binary value indicating an interest or a lack of interest. Alternatively, the tag associated with an interest path can have a range of values, for example, 1 through 10, indicating the level of interest and level of intensity in the given topic or category.

For example, where the aggregated data indicates that a given customer has 2 digital cameras peripheral to the customer processor system and that digital camera software has been used, not merely installed, within the customer processor system then the tag for the interest path of digital photography can have a positive value. (or, e.g., a value of 8 out of 10). Such a determination can be made, for example, based on a predetermined rule set that correlates multiple digital cameras and usage of digital camera software with an interest in digital photography.

In some embodiments, the value for a given interest path can change over time even where the customer processor system has not changed. Following the above example, at first time where the customer has 2 digital cameras and the tag for the digital photography interest path is positive, this tag may change to a negative value at a later time, if typical digital photography enthusiastic now have 4 digital cameras rather than 2.

At 550 the segmentation engine 162 identifies functional paths associated with the customer based on the aggregated data. A functional path can include, for example, service history or technician preference. Similar to the interest paths described above, each functional path can be associated with a tag having a binary value indicating an interest or a lack of interest, or a range of values.

For example, where the aggregated data indicates that a given customer has repeatedly worked with a given technician, then the tag for the functional path of technician preference can have a positive value (or a value within a range of values). Such a determination can be made, for example, based on a predetermined rule set that identifies a customer requesting a particular technician.

At 560 and 570, the segmentation data, the interest path data and/or the functional path data is sent to the recommendation engine 162 and the predictive engine 164, respectively.

In an alternative embodiment, the interest paths can be associated with an archetype. An archetype is a representation of an ideal or typical customer for a given interest path. For example, an archetype can be defined as having a high level of collective technical stability of the hardware components and the software components of the archetype processor system. The hardware and software components of customer processor system for such an archetype can have an advanced setup optimized for relatively-trouble free operation and a high level of performance. In other words, the hardware and software configuration of the processor system of an archetype typically yields relatively few problems even with habitual usage, and as a result, rarely requires diagnostic service. Consequently, problems for the archetype are routinely quick to solve. In such an embodiment, recommendations generated by the recommendation engine can be tailored to drive a customer profile toward the archetype's hardware and software configurations. This may result in customers being driven along one or more dimensions of FIG. 6 from low to high (e.g., neophyte to expert) resulting in fewer problems.

FIG. 7 shows a multidimensional interest table for a segmentation engine, according to an embodiment of the invention. The comfort level of a customer (such as the examples of customers described in FIG. 6) can be determined, for example, via this multidimensional interest table. As shown in FIG. 7, the interest table 700 defines multiple possible blocks based on two dimensions: interest paths and software applications.

The interest paths can be correlated with a customer's interests based on the software applications installed on the customer processor system 110. Alternatively, the interest paths can be correlated with the usage of software applications installed on a customer processor system 110. Although, the table only illustrates four interest paths and seven applications, it is not limited to these numbers.

The table elements can be selected to illustrate which software applications are installed on a particular customer processor system 110. Such selected table elements can be shown, for example, with symbols (such as a check), numerical indicators or character-based values. The selected table elements can be used to identify the interest paths of the customer and the comfort level of the customer. For the example illustrated in FIG. 7, the customer processor system 110 has the following software applications installed: skype 710, iTunes 720, and musicmatch 730. Skype, a known IP communication application, can demonstrate that the customer has an interest in IP communication and therefore has a relatively high comfort level (for example, the “Expert” column in FIG. 6). Some applications may not as indicative of an interest or a higher comfort level as others. For example, iTunes 720 is a relatively simple software application from a user perspective and designed for mass use, so the interest and the comfort level of the customer may still be low. Musicmatch 730, on the other hand, is a relatively more complex digital music application and suggests more technical proficiency by the customer. Because Photoshop was not found in table element 740 on customer processor system 110, the customer may not be interested in digital photography.

In one embodiment, the assessment of technological interest can be based on the number of selected table elements. For example, 5 or fewer selected table elements can indicate a low comfort level by the customer, 6 to 10 selected table elements can indicate a middle comfort level by the customer, and 11 or more selected table elements can indicate an expert comfort level.

In the embodiment shown in FIG. 7, the selection of table elements can include a value associated with the comfort level such a values “N” for neophyte, “M” for medium and “E” for expert. In such an embodiment, the installation of Skype can be shown in the table of FIG. 7 with the value “E” for expert. In other words, a predefined set of rules and an on-the-fly determination can be made that the installation of a particular software application is associated with a particular comfort level. In such a manner, note only the interest paths identified, the comfort level of the customer can also be reflected in a table like that shown in FIG. 7.

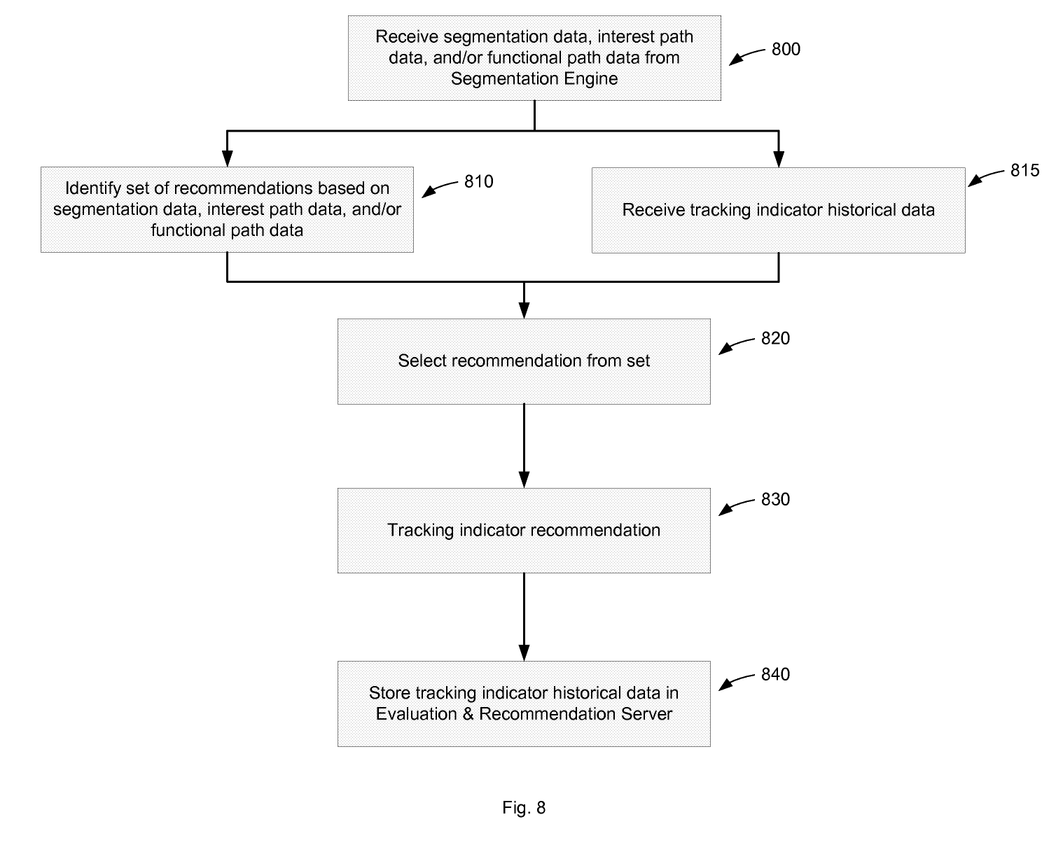

FIG. 8 shows a method for generating recommendations via a recommendation engine, according to an embodiment of the invention. At 800, the recommendation engine 163 receives the segmentation data, the interest path data and/or the functional path data from the segmentation engine 162. At 810, the recommendation engine 163 identifies a set of recommendations based on the segmentation data, the interest path data and/or the functional path data. For example, a set of recommendations can be predetermined for each segment within the multidimensional segmentation space. Following the example of FIG. 6, where the customer is identified as being associated with segment 610 because the customer is a neophyte with low technical stability, the recommendation engine 162 can identify the related set of recommendations.

A set of recommendations can be, for example, in the form of a prioritized list. For example, the set of recommendations for segment 610 can include (1) downloading the latest operating system (OS) updates, (2) upgrading to the next version of OS or other relevant software, (3) adding a second hard disc drive, etc. The prioritized list can be, for example, from the highest priority (e.g., the most helpful recommendation) to the lowest priority (e.g., the least helpful recommendation). These recommendations can be previously identified as being helpful based on prior customer experiences and from a statistical perspective.

In an alterative embodiment, the recommendations for the technician can include the most appropriate contact means for a given customer. For example, a customer with the designation of neophyte in comfort level can be contacted through direct mail, an audio phone, etc. A customer with a higher comfort level can be contacted via more technologically sophisticated means such as electronic mail, online-chats, etc. The customer-tailored technician contact can reduce the amount of miscommunications between the technician and customer as well as reduce the amount of time needed for the technician to convey the solution to the customer.

In some embodiments, the recommendations for the technician can include specific recommendations and/or instructions for the technician to address the problem as customer processor system 110. Problem resolution data along with information about the problem, the customer's profile, and history of implemented recommendations, for example, can form the basis by which customer-tailored specific recommendations/instructions can be identified. The recommendation can include, for example, instructions to uninstall a specific software, reboot the computer, and check if the problem still exists. Of course, any number of recommendations are possible as appropriate for the given problem.

In another alterative embodiment, the set of recommendations for each segment can be previously determined to drive a customer from low segment to high segment. In other words, the set of recommendations for a given segment (particularly segments having a lower dimension value) can be prioritized so that a customer accepting the recommendations will change its profile from one segment to a higher segment along one or more dimensions when the aggregated data for that customer is again analyzed by the segmentation engine 162.

At 815, the recommendation engine 162 receives historical data from evaluation-and-recommendation database 165 based on the segmentation data, the interest path data and/or the functional path data. The historical data can include, for example, a history of prior recommendations for this customer and a history of prior responses by this customer to those recommendations. Similarly, the historical data can include, for example, a history of prior recommendations for a technician and associated with this customer, and a history of prior responses by this technician to those recommendations.

At 820, a particular recommendation from the set of recommendations can be selected. Once selected, the selected recommendation can be assigned a tracking indicator by the recommendation engine 163 at 830 and a tracking-indicator history for that customer can be stored, for example, in evaluation-and-recommendation database 165 at 840. Maintaining this tracking history allows the recommendation engine 163 to track and rotate the selected recommendation from the set of recommendationsH. In other words, the tracking indicator enables the tracking of previous responses to prior recommendations, which prevents the sending of a duplicate recommendation and/or a recommendation the customer has not historically accepted.

Recommendations by the recommendation engine 163 can be sent to the customer processor system 110 or technician processor system 120 as described above in connection with steps 370 through 385 of FIG. 3. In other words, after recommendations are sent to the proper recipient, new characterization data can be collected and processed by the remote client 111 and sent to the data aggregator 161 for further processing, potentially repeating the process of segmentation and recommendation.

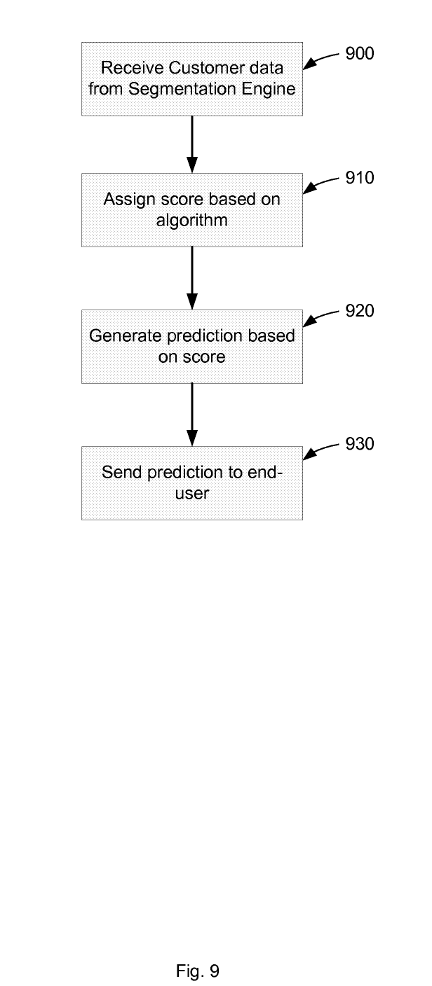

FIG. 9 shows a method of predicting customer behavior via a predictive engine, according to an embodiment of the invention. At 900, the predictive engine 164 receives aggregated data 800 from the segmentation engine 162. At 910, the predictive engine 162 assigns a score to the customer using, for example, a predefined algorithm or rule set for metrics of interest. Such metrics can include, for example, the likelihood of the customer experiencing future technical problems with hardware components of customer processor system 110, the likelihood of the customer experiencing future technical problems with software components of customer processor system 110, etc. The score can be calculated based on, at least in part, on the aggregated data received from the data aggregator 161 and the segment identified for that customer by the segmentation engine 162. A different predictive algorithm or rule set can be associated for each type of metric. Alternatively, predictive algorithms or rule sets can be interrelated and associated with multiple metrics.

At 920, the predictive engine 164 generates predictions associated with customer based on the one or more scores. For example, the customer is associated with a high score indicative that the customer will likely experience future technical problem with hardware components and a low score indicative that the customer will likely experience future technical problems with software components, the predictive engine 164 can generate a prediction that the customer will likely switch internet service providers (ISPs).

At 930, the predictive engine 164 sends predictions to specific recipients, such as the customer, recommendation engine 163, and/or a third party, appropriate for the predictions. Following the example of a customer likely to switch their ISP, such a prediction can be provided from the predictive engine 164 to the customer ISP. The customer's ISP can then make service decisions for that customer based on the prediction. For example, the customer's ISP may decide to offer the customer a promotional discount in an attempt to retain the customer. Alternatively, the customer's ISP may decide to assign that customer a low priority for service calls given the likelihood that the customer will switch ISPs in the near future. In yet another alternative, the predictions sent to the recommendation engine 163 result in the recommendation engine generating a recommendation to update or upgrade software and/or hardware for the customer processor system 110 that can reduce the likelihood of the customer switching its ISP. Such recommendations can be sent to the customer at customer processor system 110 to seek the customer's acceptance of the recommendations.

In an alternative embodiment, the predictive engine also performs a validation process where post-prediction results are collected and the predefined algorithms and/or rule sets are evaluated based on the post-prediction results. Where the post-prediction results do not match the predictions, the predefined algorithms and/or rule sets can be modified. This allows the prediction engine 164 to evolve the accuracy of its predictions over time and over a sufficient sample set.

In one embodiment, the predictions and/or post-prediction results can be provided to third parties such as software companies. Such software companies can, for example, have their software tested on a niche customer base and get customer usage results within that niche customer base via the predictions and/or post-prediction results. For example, the installation or usage of a particular software application by a particular the type of customer or prediction about such installation or usage can be informative to a third party such as software company for example in terms of tracking the customer types.

Alternatively, a third party such as a software company can make marketing decisions based on early usage results. In this example, a software company that find quick or wide adoption of a new software package may decide to engage in a marketing campaign to promote the software package that will likely be very successful. Similarly, the software company may decide to cut back on marketing plans when a new software package is not being adopted quickly or in a wide-spread manner upon release.

According to another embodiment of the invention, an intelligent routing system can be used to service a customer at customer processor system 110 based on any number of possible customer preferences. For example, a customer can be routed to a specific technician based on the preferences of that customer. Such preferences can include, for example, a previously-identified preference for a specific technician. Alternatively, such preferences can be predicted based on information about the customer such as the customer's age, the software applications used by the customer, the amount of service usage, a payment preference and a communication preference. Based on one or more these preferences, the customer can be matched with a specific technician, for example, a technician particularly effective with that type of customer with the associated type of processor system and types of problems.

As discussed above, the customer processor system 110 is scanned by the remote client 111 as part of the characterization process and inquiries about a given problem can be sent by the customer. A set of predefined rules including but not limited to, technician skill, technician availability, nature of the problem, and type of customer, can more closely match the customer with a technician. A fully automated, real-time performance management tool evaluates the technicians across multiple dimensions and ranks them to also aid in the customer-technician matching process. This management tool can enable the allocation of work and rewards for technicians based on the technician's rank.

In another alternate embodiment of the invention, an ancillary system can automatically diagnose and correct problems. The ancillary system is similar to the previously described system of FIG. 1, but a technician processor system 120, and sales processor system 130 are not necessary. The remote client 111 executes in the same fashion as discussed in the previously described system. In this embodiment, however, everything from the download of the remote client 111 installation software to the implementation of a diagnostic-based solution can be fully automated, thereby eliminating the need for human interaction by the customer or a technician.

In an alternative embodiment, customers can opt into a community to share the problem solving techniques among the community members. For example, customers with similar interest areas (discussed above) can be the basis of the grouping of each community. Members of the same community can communicate among one another to obtain advice. Furthermore, the recommendation engine 163 can use recommendations of community members to generate more effective solutions for future recommendations.

In this embodiment, the evaluation-and-recommendation server 160 can send instructions directly to the remote client 111 without sending them to the technician processor system 120. The remote client 111 then automatically can execute the instructions at the customer processor system 110 without the interaction of the customer. The instructions here can be a command script. The remote client 111 can inform the customer of the implemented recommendations through a pop-up dedicated window or a triggered dedicated window. The remote client 111 can send post-execution characterization data to the application server for future use.

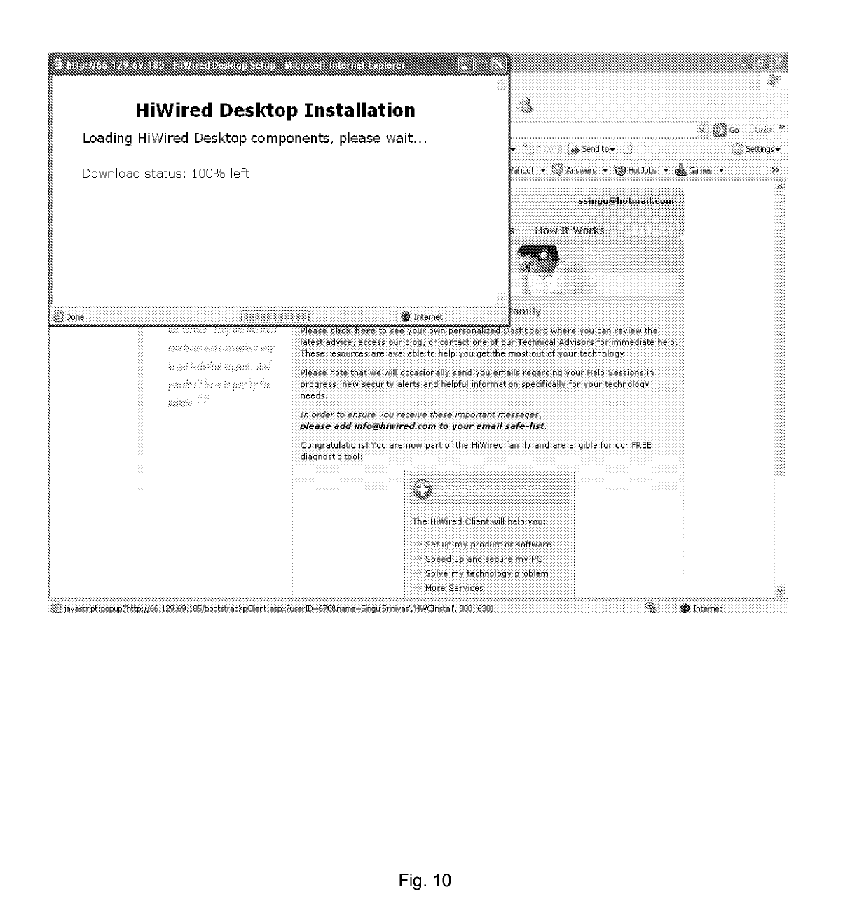

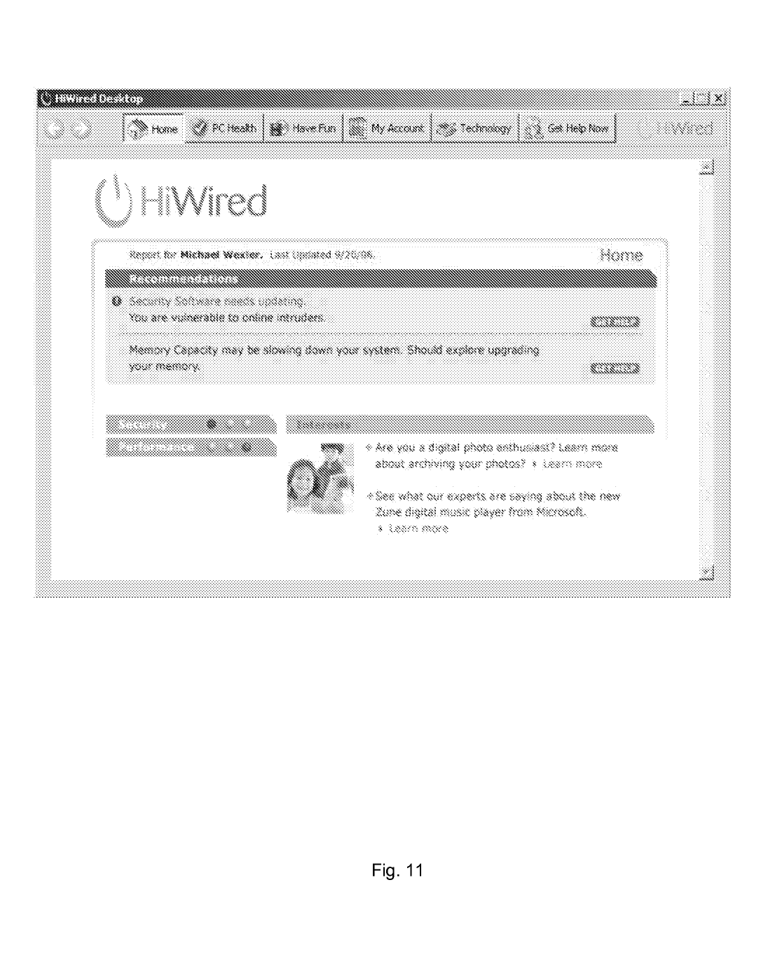

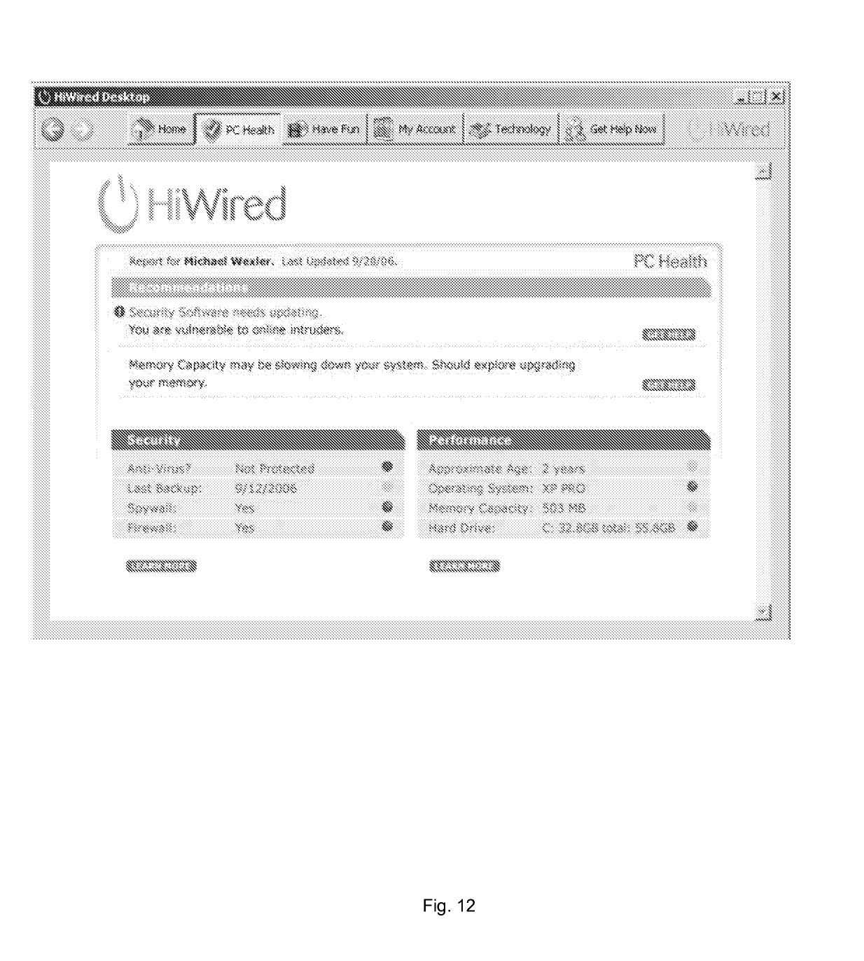

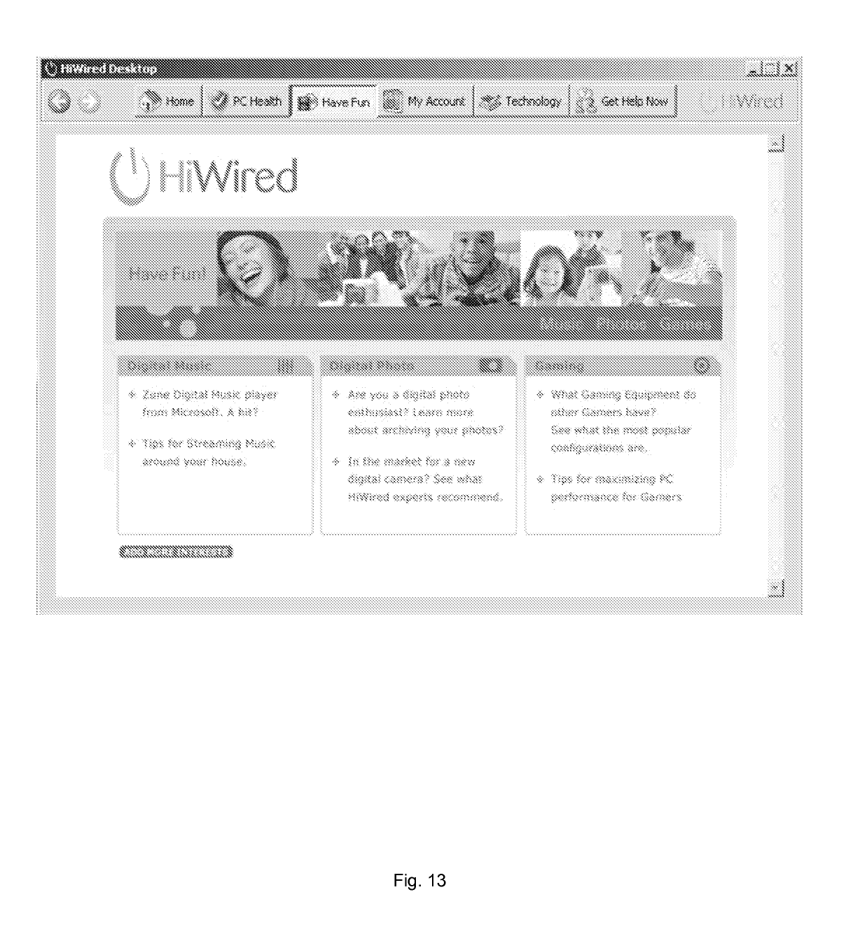

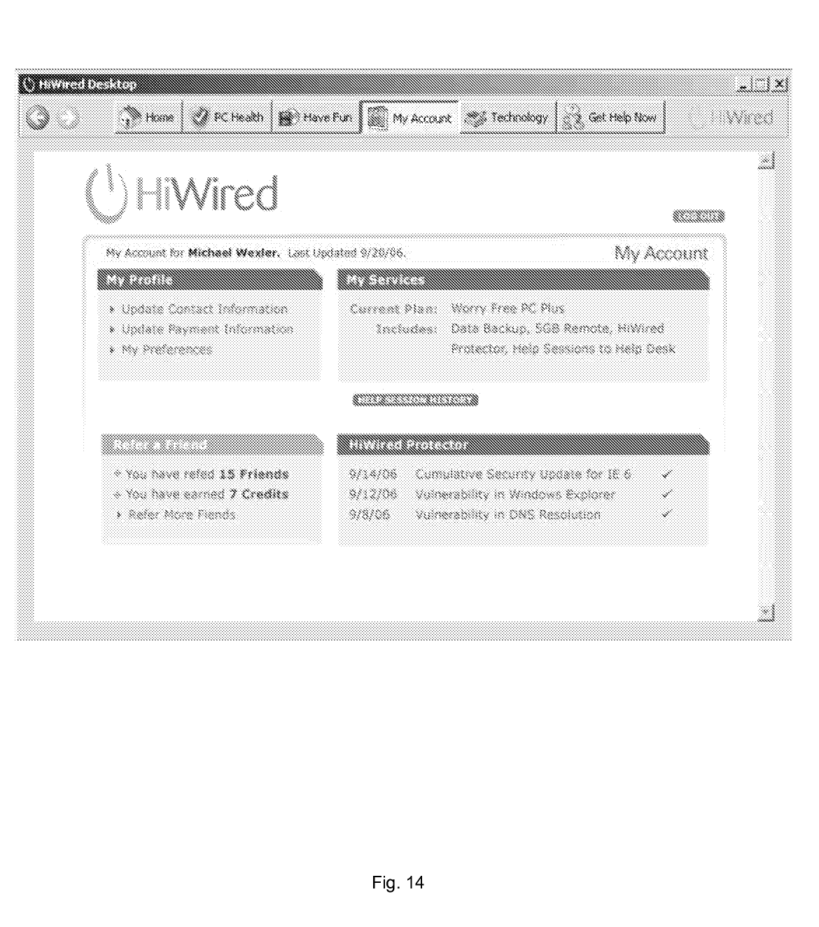

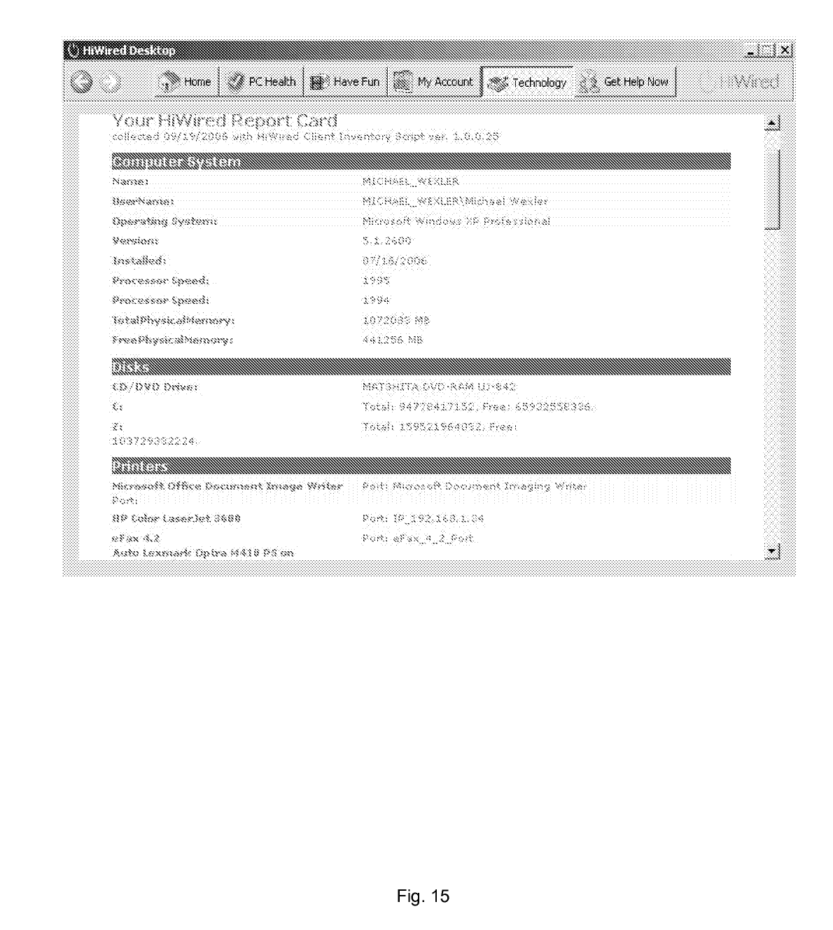

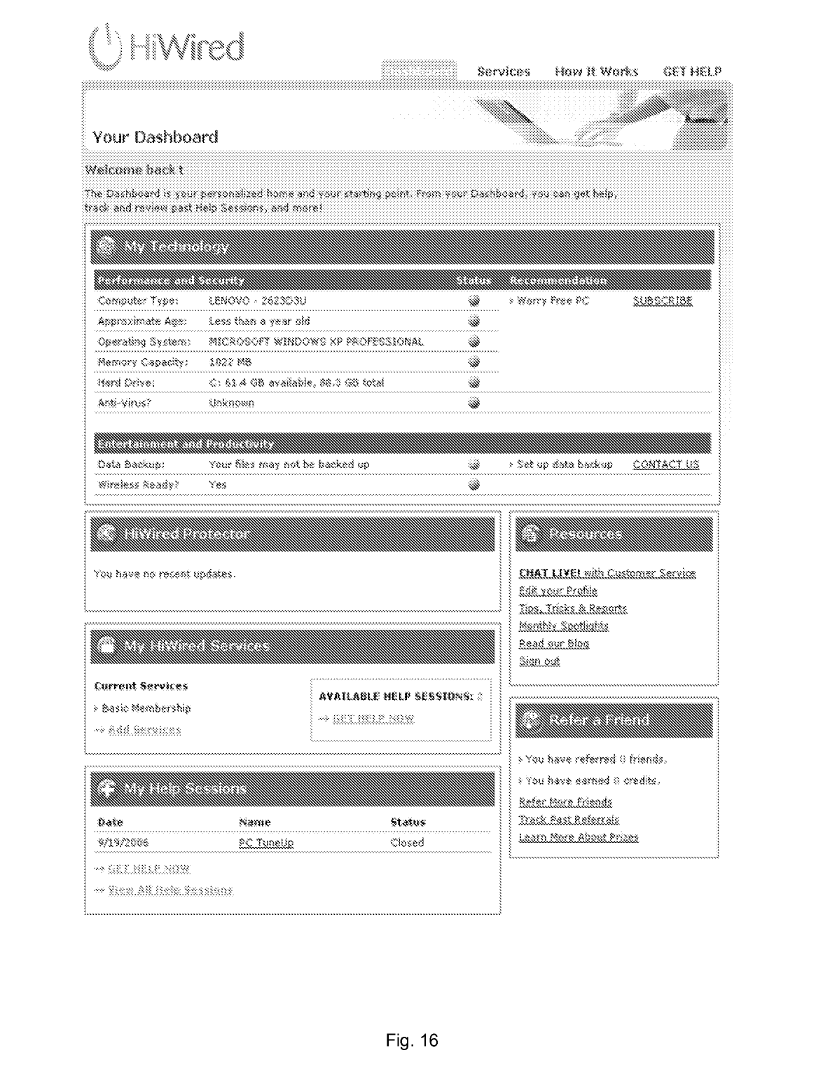

FIGS. 10 through 16 show examples of the types of information presented to and collected from a customer associated with customer processor system 110, according to an embodiment of the invention. FIG. 10 shows an example of a graphical user interface (GUI) showing enrollment by the customer and installation of the remote client 111 at customer processor system 110. FIG. 11 shows an example of a GUI displaying characterization data in the form of colored indicators and displaying recommendations. FIG. 12 shows another example of a GUI displaying more detailed characterization data in addition to colored indicators and displaying recommendations. FIG. 13 shows an example of a GUI displaying interest paths and inviting the customer to seek recommendations. FIG. 14 shows another example of a GUI displaying characterization data. FIG. 15 shows yet another example of a GUI displaying characterization data. FIG. 16 shows yet another example of a GUI displaying characterization data including colored indicators and displaying multiple other status windows.

Some embodiments relate to a computer storage product with a computer-readable medium (also can be referred to as a processor-readable medium) having instructions or computer code thereon for performing various computer-implemented operations. The media and computer code (also can be referred to as code) may be those specially designed and constructed for the specific purpose or purposes. Examples of computer-readable media include, but are not limited to: magnetic storage media such as hard disks, floppy disks, and magnetic tape; optical storage media such as Compact Disc/Digital Video Discs (CD/DVDs), Compact Disc-Read Only Memories (CD-ROMs), and holographic devices; magneto-optical storage media such as optical disks; carrier wave signals; and hardware devices that are specially configured to store and execute program code, such as Application-Specific Integrated Circuits (ASICs), Programmable Logic Devices (PLDs), and ROM and RAM devices. Examples of computer code include, but are not limited to, micro-code or micro-instructions, machine instructions, such as produced by a compiler, and files containing higher-level instructions that are executed by a computer using an interpreter. For example, an embodiment of the invention may be implemented using Java, C++, or other object-oriented programming language and development tools. Additional examples of computer code include, but are not limited to, control signals, encrypted code, and compressed code.

In conclusion, among other things, methods and apparatus for diagnosis and recommendations for a remote processor system are described. While various embodiments have been described above, it should be understood that they have been presented by way of example only, and various changes in form and details may be made. For example, the evaluation-and-recommendation server can produce recommendations based, in part, on data sent from the tech processor system.

What is claimed is:

1. A processor-readable medium storing code representing instructions to cause a processor to perform a process, the code comprising code to:
receive characterization data from a remote processor system based on characteristics of the remote processor system; and
produce a recommendation including a message associated with the user of the remote processor system based on the characterization data, the message including information associated with improving performance of the remote processor system.

2. The processor-readable medium of claim 1, the code further comprising code to:
predict a preferred communication channel of a user of the remote processor system through which the user is most likely to receive the message.

3. The processor-readable medium of claim 2, wherein the predicted preferred communication channel is at least one of a direct-mail channel, an electronic mail channel, a dedicated messaging window channel at the remote processor system and a telephone channel.

4. The processor-readable medium of claim 1, wherein the message is an advertisement.

5. The processor-readable medium of claim 1, the code further comprising code to:
send the message to the remote processor system of the user such that the message is output via a dedicated window at the remote processor system.

6. The processor-readable medium of claim 1, the code further comprising code to:
send the message to the user of the remote processor system via a predicted preferred communication channel;
receive a response to the message from the user of the remote processor system; and
update a recommendation engine based on at least one of the response, the characterization data, the recommendation and the predicted preferred communication channel.

7. A processor-readable medium storing code representing instructions to cause a processor to perform a process, the code comprising code to:
receive characterization data from a remote processor system, the characterization data being based on characteristics of the remote processor system, the characterization data including data associated with software of the remote processor system and data associated with hardware of the processor system; and
produce a recommendation based on the characterization data of the processor system, the recommendation including instructions to improve performance of the processor system.

8. The processor-readable medium of claim 7, wherein the recommendation is specific to a user-defined issue.

9. The processor-readable medium of claim 7, the code further comprising code to:
output the recommendation to the remote processor system such that the recommendation is automatically executed by the remote processor system.

10. The processor-readable medium of claim 7, wherein characterization data is produced by a software application of the remote processor system.

11. The processor-readable medium of claim 7, wherein the characterization data is a first set of characterization data, the code to receive the first set of characterization data is at a first time, the code further comprising code to:
receive a second set of characterization data from the remote processor system at a second time different than the first time, the characterization data of the second set being based on characteristics of the remote processor system.

12. The processor-readable medium of claim 7, wherein the recommendation is a first recommendation, the code to produce the first recommendation is at a first time, the code further comprising code to:
produce a second recommendation based on the characterization data of the remote processor system at a second time different than the first time, the second recommendation including instructions to improve performance of the remote processor system.

13. A processor-readable medium storing code representing instructions to cause a processor to perform a process, the code comprising code to:
receive registration information associated with a user and a processor system of the user;
send a software application to the processor system, the software application configured to output a dedicated window; and
push a message to the processor system such that the message is displayed to the user of the processor system within the dedicated window, the message including information associated with improving the processor system.

14. The processor-readable medium of claim 13, wherein the message is a recommendation to improve the processor system.

15. The processor-readable medium of claim 13, wherein the message is an advertisement of an item to improve the processor system, the advertisement including a portion of the registration information associated with the user and the processor system of the user.

16. The processor-readable medium of claim 13, the code further comprising code to:
receive characterization data from the processor system produced by the software application.

17. The processor-readable medium of claim 13, the code further comprising code to:
receive a response associated with the message from the processor system.

18. The processor-readable medium of claim 13, wherein the message is a first message, the code to push the first message is at a first time, the code further comprising code to:
push a second message to the processor system such that the message is displayed to the user of the processor system within the dedicated window at a second time different than the first time, the message including a portion of the registration information associated with the user and the processor system of the user.

19. A processor-readable medium storing code representing instructions to cause a processor to perform a process, the code comprising code to:
receive a software application from a first party;
receive a software application from a second party different from the first party, the software application associated with the second party being different than the software application associated with the first party; and
produce a local software application configured to execute features from the software application associated with the first party and to execute features of the software application associated with the second party.

20. The processor-readable medium of claim 19, the code further comprising code to:
modify the local software application such that the local software application is configured to execute features of a software application associated with a third party different from the first party and the second party.

21. The processor-readable medium of claim 19, the code further comprising code to:
modify the local software application such that the local software application is inhibited from executing a feature of the software program associated with the first party.

22. The processor-readable medium of claim 19, the code further comprising code to:
install the software application associated with the first party on a processor system via the local software application;
execute automatically features of the software program associated with the first party on the processor system; and
uninstall automatically the software program associated with the first party from the processor system.

23. The processor-readable medium of claim 19, wherein the software application associated with the first party is a security software application.

24. The processor-readable medium of claim 19, the code further comprising code to:
execute a feature of the software application associated with the first party via the local software application; and
execute a feature of the software application associated with the second party via the local software application.

25. The processor-readable medium of claim 19, wherein the local software application is configured to execute features of the local software application.
